(19) United States
(12) Patent Application Publication
(10) Pub. No.: US 2016/0326999 A1
(43) Pub. Date: Nov. 10, 2016

(54) Fuel Injection Device and Fuel Injection Valve

(71) Applicant: Hitachi Automotive Systems, Ltd., Hitachinaka-shi (JP)

(72) Inventor: Tae-Kyung KIM, Troy, MI (US)

(21) Appl. No.: 14/705,093

(22) Filed: May 6, 2015

(51) Int. Cl. F02M 55/00; F02M 61/04; F02M 55/02

(52) U.S. Cl. CPC F02M 55/005; F02M 55/025; F02M 61/04

(57) ABSTRACT

An object of the invention is to provide amounting structure with which an operation for mounting a fuel injection valve on a receiving portion can be simplified. A fuel injection device provided with a fuel rail and a fuel injection valve includes a first lock mechanism 109, 209a regulating a movement of a fuel injection valve 200 in a central axis direction with respect to a receiving portion 103 and a second lock mechanism 110, 207 regulating a rotational movement of the fuel injection valve 200 about a central axis. The second lock mechanism has a radially protruding portion 207 and a fitting groove 110b. The fuel injection device is in a lock state, with the first lock mechanism 109, 209a engaged and the radially protruding portion 207 fitted into the fitting groove 110b, in a case where the fuel injection valve 200 rotates about the central axis.

### TECHNICAL FIELD

The present invention relates to a mounting structure for a fuel rail and a fuel injection valve used in an internal combustion engine.

### BACKGROUND ART

In the related art relating to this technical field, US2012/0031996A (PTL 1) discloses a structure in which a plate that has a tab which is disposed to extend radially outward is mounted between a fuel inlet side end portion and a fuel outlet side end portion of a fuel injection valve and the fuel injection valve is mounted on a fuel cup by using this plate. In this mounting structure, a ledge that is disposed to extend radially inward is disposed in an intermediate portion of a cavity portion of the fuel cup, the plate is inserted into the cavity portion of the fuel cup, and then the fuel injection valve and the plate are allowed to rotate, about a central axis of the fuel injection valve, to a lock position and the tab of the plate is put on the ledge of the fuel cup so that separation of the fuel injection valve from the fuel cup is prevented. In addition, a retainer is inserted, at the lock position, from an opening that is disposed in the fuel cup to a notch that is disposed in an outer circumferential surface of the tab so that positions of the fuel injection valve and the plate in rotational directions with respect to the fuel cup are fixed. The fuel cup is also referred to as injector cup, fuel injection valve receiving member, or fuel injection valve receiving portion. In the following description, the fuel cup will be referred to as fuel injection valve receiving portion.

### CITATION LIST

### Patent Literature

PTL 1: US2012/0031996A

### SUMMARY OF INVENTION

### Technical Problem

In the mounting structure according to PTL 1, the retainer is required for fixing the positions of the fuel injection valve and the plate in the rotational directions with respect to the fuel injection valve receiving portion, and thus a retainer assembly operation is required. The retainer is a small component, and significant skills are required for quickly performing the operation for fixing the positions of the fuel injection valve and the plate in the rotational directions with respect to the fuel injection valve receiving portion by inserting the retainer into the small opening disposed in the fuel injection valve receiving portion.

An object of the invention is to provide amounting structure with which an operation for mounting a fuel injection valve on a fuel injection valve receiving portion can be simplified.

### Solution to Problem

In order to achieve the above-described object, the invention provides a fuel injection device including a fuel rail and a fuel injection valve, the fuel rail having a fuel injection valve receiving portion receiving the fuel injection valve and a fuel inlet side end portion of the fuel injection valve being inserted into and fixed to the fuel injection valve receiving portion, the fuel injection device further including a first lock mechanism regulating a movement of the fuel injection valve in a central axis direction with respect to the fuel injection valve receiving portion, and a second lock mechanism regulating a rotational movement of the fuel injection valve about a central axis, in which the first lock mechanism has engagement portions respectively disposed in the fuel injection valve receiving portion and the fuel injection valve, the second lock mechanism has a radially protruding protrusion-shaped portion in one of the fuel injection valve receiving portion and the fuel injection valve and a fitting groove into which the protrusion-shaped portion is fitted in the other one of the fuel injection valve receiving portion and the fuel injection valve, and the fuel injection device is in a lock state, with the engagement portion of the first lock mechanism engaged and the protrusion-shaped portion of the second lock mechanism fitted into the fitting groove, in a case where the fuel injection valve rotates about the central axis.

### Advantageous Effects of Invention

According to the invention, an operation for mounting the fuel injection valve on the fuel injection valve receiving portion can be simplified and operation efficiency can be improved. Accordingly, productivity of the fuel injection device that has the fuel rail and the fuel injection valve can be improved.

### BRIEF DESCRIPTION OF DRAWINGS

FIG. 1 is a configuration diagram illustrating a cross section of a part of a mounting structure for a fuel injection valve according to an embodiment of the invention.

FIG. 2 is an enlarged cross-sectional view of the II part in FIG. 1.

FIG. 3A is a cross-sectional view taken along arrow III-III in FIG. 1, illustrating a state where the fuel injection valve is inserted into and unlocked in a fuel injection valve receiving portion of a fuel rail (unlock state).

FIG. 3B is a view illustrating a state where the fuel injection valve is locked in the fuel injection valve receiving portion of the fuel rail (lock state).

FIG. 4A is an external view illustrating a state where the fuel injection valve 200 according to first embodiment is mounted on the fuel injection valve receiving portion 103.

FIG. 4B is a horizontal cross-sectional view illustrating a position where the plate 209 is mounted on the fuel injection valve 200.

FIG. 5 is for describing the method for mounting the fuel injection valve 200 on the fuel injection valve receiving portion 103.

FIG. 6 is a cross-sectional view of the fuel injection valve receiving portion 103 (injector cup) and the plate 209 mounted on the fuel injection valve 200 according to second embodiment.

### DESCRIPTION OF EMBODIMENTS

Hereinafter, embodiments of the invention will be described with reference to accompanying drawings.

### First Embodiment

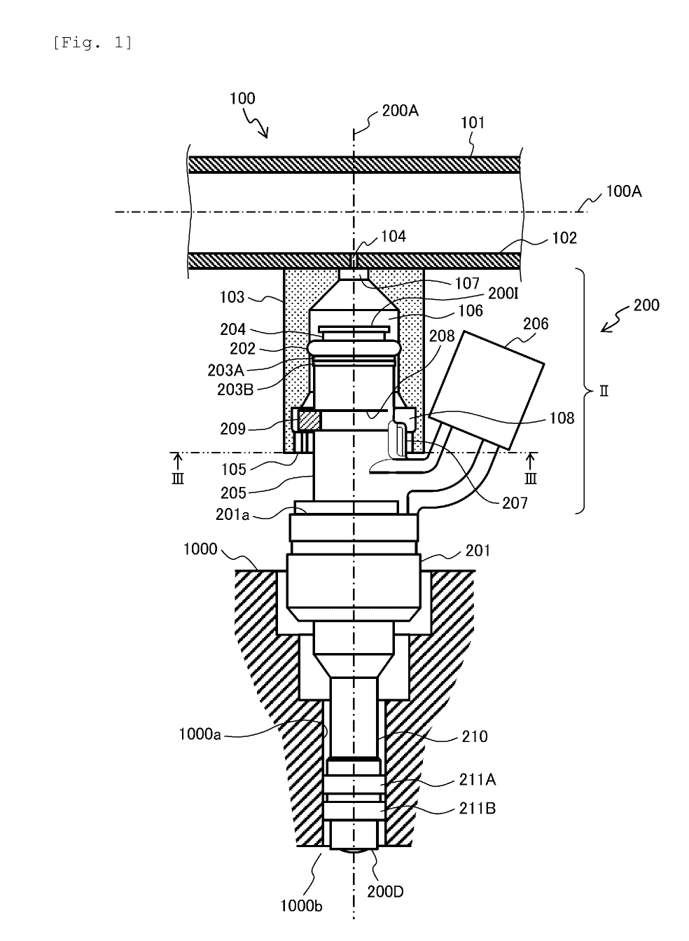

FIG. 1 is a configuration diagram illustrating a cross section of a part of a mounting structure for a fuel injection valve 200 according to a first embodiment of the invention. The mounting structure for the fuel injection valve according to the invention is applied to a fuel injection device that is provided with a fuel rail 100 and the fuel injection valve 200. In other words, the mounting structure for the fuel injection valve according to the invention is realized by the fuel rail 100 and the fuel injection valve 200.

In the following description, an up-and-down direction or a position relating to the up-and-down direction is defined based on FIG. 1. The up-and-down direction may not mean an up-and-down direction in a state of being mounted on a vehicle.

The fuel rail 100 has a fuel rail main body 101 that constitutes an accumulator and a fuel injection valve receiving portion 103 that receives the fuel injection valve 200. The fuel rail main body 101 is a member in which a central axis 100A direction is a longitudinal direction. The fuel rail main body 101 is a cylindrical member that has a central hole 102 along the central axis 100A. The central hole 102 constitutes the accumulator that stores a fuel. Usually, a plurality of the fuel injection valve receiving portions 103 are disposed along the central axis 100A. The number of the fuel injection valve receiving portions 103 disposed depends on the number of cylinders and the number of the fuel injection valves arranged in the respective cylinders.

A through-hole 104 that allows the central hole 102 to communicate with the outside of the fuel rail main body 101 is disposed in the fuel rail main body 101. A concave portion (space) 106, which is recessed toward the fuel rail main body 101 side from an end surface (lower end surface) 105 on the side opposite to a side connected to the fuel rail main body 101, is formed in the fuel injection valve receiving portion 103. A through-hole 107, which allows the concave portion 106 to communicate with the outside of the fuel injection valve receiving portion 103, is formed at a bottom of the concave portion 106. The fuel injection valve receiving portion 103 is connected to an outer circumferential surface of the fuel rail main body 101 so that the through-hole 107 and the through-hole 104 communicate with each other. The fuel injection valve receiving portion 103 may be integrally molded with the fuel rail main body 101.

A groove portion (diameter-increased space portion) 108 that increases a diameter of an inner space is formed, close to the lower end surface 105, in an inner circumferential surface of the concave portion 106.

In this embodiment, an example in which an electromagnetic fuel injection valve that drives a valve element by using an electromagnetic force is used as the fuel injection valve 200 is described. The fuel injection valve 200 may be a piezoelectrically driven fuel injection valve or a fuel injection valve adopting another driving method.

The fuel injection valve 200 forms a vertically long shape in a direction along a central axis 200A. A fuel inlet is open in an upper end portion of the fuel injection valve 200 and a fuel pipe 204 constitutes the fuel inlet. Accordingly, the upper end portion of the fuel injection valve 200 will be referred to as a fuel inlet side end portion 200I. A fuel outlet is disposed in a lower end portion of the fuel injection valve 200. Accordingly, the lower end portion of the fuel injection valve 200 will be referred to as a fuel outlet side end portion 200D. The fuel inlet side end portion 200I will be referred to as a base end portion of the fuel injection valve 200 and the fuel outlet side end portion 200D will be referred to as a tip portion of the fuel injection valve 200 as the case may be.

The fuel injection valve 200 has an electromagnetic driving unit 201 in an intermediate portion between the fuel inlet side end portion 200I and the fuel outlet side end portion 200D. An annular seal member 202 and backup rings 203A and 203B that back up the annular seal member 202 are disposed in the vicinity of the fuel inlet side end portion 200I. The annular seal member 202 is a member that is made of elastic rubber and prevents fuel leakage.

A resin portion 205 that covers an outer circumferential surface of the fuel pipe 204 is disposed between an upper end 201a of the electromagnetic driving unit 201 and a lower end surface of the backup ring 203B. A connector 206 is disposed in the resin portion 205 so as to perform electrical connection to an external circuit. The connector 206 is molded with the resin portion 205 that covers the outer circumferential surface of the fuel pipe 204.

A protrusion-shaped portion 207 that protrudes radially outward is formed in the resin portion 205. The protrusion-shaped portion 207 is molded with the resin portion 205 as is the case with the connector 206. A groove portion 208 is formed at a part of the resin portion 205 where the protrusion-shaped portion 207 is not formed. A member (plate) 209 that forms a C-shaped annular shape with a notch at a part of an annular member is fitted into the groove portion 208. When the plate 209 is mounted, the plate 209 is positioned in the groove portion 108 of the fuel injection valve receiving portion 103.

A nozzle portion 210 where the diameter is minimized is disposed closer to the fuel outlet side end portion 200D side than to the electromagnetic driving unit 201. When the nozzle portion 210 is mounted on an engine, the nozzle portion 210 is inserted into a fuel injection valve insertion hole 1000a that is formed in a cylinder head 1000. In this case, the fuel outlet side end portion 200D faces the inside of a combustion chamber 1000b. Two chip seals 211A and 211B are disposed in an intermediate portion of the nozzle portion 210. The chip seals 211A and 211B are pinched by the nozzle portion 210 and an inner circumferential surface of the fuel injection valve insertion hole 1000a and receive a compressive force. The chip seals 211A and 211B prevent an air-fuel mixture of the fuel and air or a combustion gas obtained after combustion from leaking out of the combustion chamber 1000b through the fuel injection valve insertion hole 1000a.

Various methods can be considered for assembling the fuel injection device. In general, an assembled product (fuel injection device) in which the fuel injection valve 200 is assembled with the fuel rail 100 is completed and the fuel rail 100 and the fuel injection valve 200 are integrally assembled with the engine. In this embodiment, an example in which the fuel injection valve insertion hole 1000a is disposed in the cylinder head 1000 is described. However, the fuel injection valve insertion hole 1000a may be disposed in a component constituting the combustion chamber other than the cylinder head 1000, an intake pipe, or the like.

Hereinafter, the electromagnetic driving unit 201 of the electromagnetic fuel injection valve 200 according to this embodiment will be further described.

The electromagnetic driving unit 201 has an electromagnet. A fixed core and a coil constitute the electromagnet. The electromagnetic driving unit 201 is configured to suction a movable core by using an electromagnetic force that is generated in the fixed core when the coil is energized. The electromagnetic driving unit 201 accommodates the fixed core, the coil, and the movable core, and forms a portion that is larger in diameter than the other parts.

The valve element is connected to the movable core, and the valve element is separated from a valve seat and is opened when the movable core is suctioned to the fixed core. In a state where the coil is not energized, the valve element receives a biasing spring force, abuts against the valve seat, and is closed. The valve element and the valve seat constitute a fuel seat portion. The valve element, the valve seat, and the seat portion are disposed inside the fuel injection valve 200 and in the vicinity of the fuel outlet side end portion 200D. A fuel injection hole that allows an inner fuel passage to communicate with the outside is formed in the fuel outlet side end portion 200D. The fuel passing through the seat portion when the valve element is open is injected to the outside through the fuel injection hole.

Next, a mounting structure for the fuel injection valve 200 will be described.

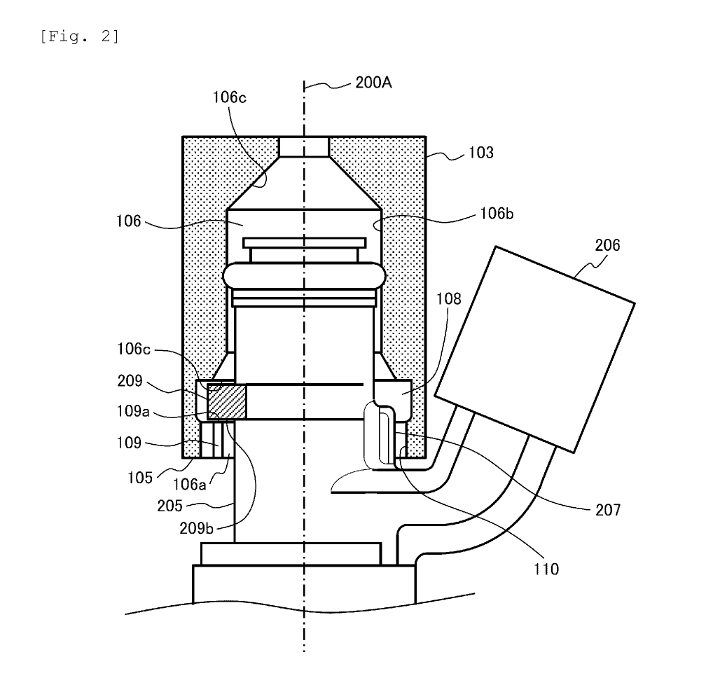

FIG. 2 is an enlarged cross-sectional view of the II part in FIG. 1.

An inlet opening 106a of the concave portion 106, into which the fuel inlet side end portion 200I of the fuel injection valve 200 is inserted, is open in the lower end surface 105 of the fuel injection valve receiving portion 103. A plurality of (five in this embodiment) protruding portions 109 that protrude radially inward are disposed, at intervals in a circumferential direction, in the inlet opening 106a.

A groove portion 108 is formed, in an annular shape, on an inner side of the protruding portion 109. A cylindrical surface portion 106b, which is smaller in diameter than the groove portion 108, is formed in a direction along the central axis 200A on an inner side of the groove portion 108. The fuel injection valve 200 is inserted into the concave portion 106 so that the plate 209 is positioned in the groove portion 108. In other words, the plate 209 is more inserted into the inner side than the protruding portion 109. Accordingly, an inner diameter of the groove portion 108 is larger than an outermost diameter of the plate 209 and the outermost diameter of the plate 209 is larger than an inner diameter of an opening surface of the cylindrical surface portion 106b.

The annular seal member 202 of the fuel injection valve 200 abuts against an inner circumferential surface of the cylindrical surface portion 106b, and the fuel stored in the concave portion 106 closer to the inner side than the annular seal member 202 is prevented from leaking to the outside. Accordingly, an outer diameter of the annular seal member 202 is larger than an inner diameter of the cylindrical surface portion 106b. According to FIG. 2, an outer circumferential portion of the annular seal member 202 bites into the inner circumferential surface of the cylindrical surface portion 106b. This is to help understand a relationship between the outer diameter of the annular seal member 202 and the inner diameter of the cylindrical surface portion 106b. In reality, the annular seal member 202 is pinched and deformed between the cylindrical surface portion 106b and the fuel pipe 204.

On an inner side of the cylindrical surface portion 106b, a conical surface portion 106c that has a diameter gradually decreasing toward the inner side from the inner diameter of the cylindrical surface portion 106b is formed. An innermost portion of the conical surface portion 106c is connected to the through-hole 107.

In the fuel injection valve 200, the protrusion-shaped portion (self locking tap) 207 that protrudes radially outward is formed on an outer circumferential surface of the resin portion 205. The protrusion-shaped portion 207 is formed to correspond in position to a position in a depth direction of the concave portion 106 where the protruding portion 109 is formed. This is because a lock groove (locking groove) 110, which holds the protrusion-shaped portion 207 at a lock position (lock position), is formed at the same position as a position in the depth direction of the concave portion 106 where the protruding portion 109 is formed.

The protrusion-shaped portion 207 is formed toward the fuel inlet side end portion 200I from a root portion of the connector 206. Preferably, the protrusion-shaped portion 207 is disposed at a zero-degree, 90-degree, 180-degree, or 270-degree angular position about the central axis 200A on the basis of the connector 206. In this case, the protrusion-shaped portion 207 can be easily molded, with the connector 206, in the resin portion 205.

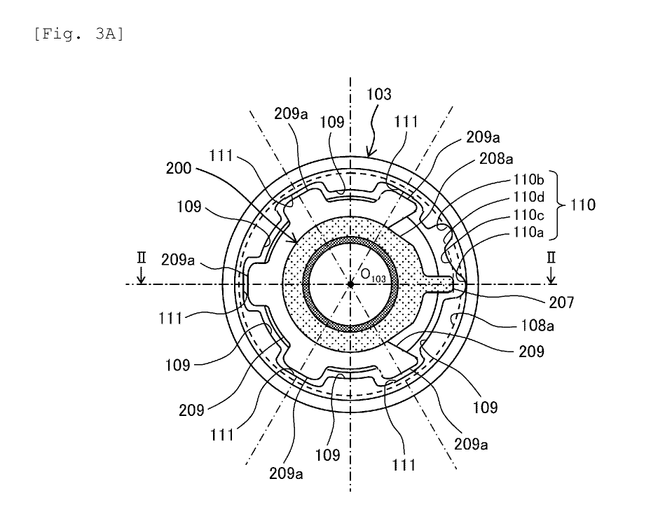

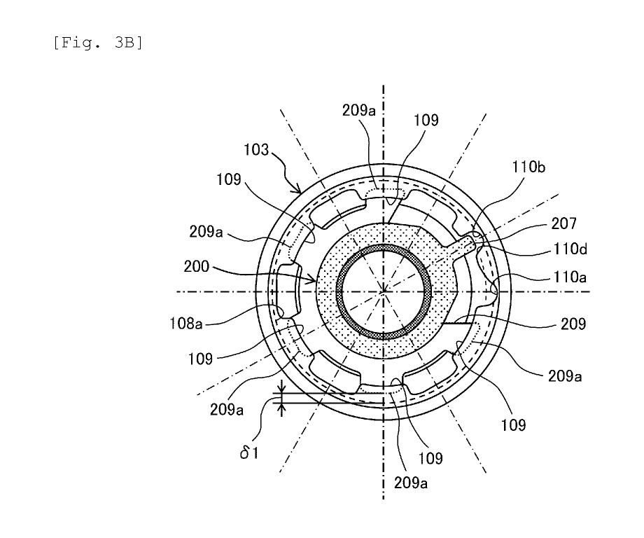

FIG. 3A is a cross-sectional view taken along arrow III-III in FIG. 1, illustrating a state where the fuel injection valve 200 is inserted into and unlocked in the fuel injection valve receiving portion 103 of the fuel rail 100 (unlock state). FIG. 3B is a view illustrating a state where the fuel injection valve 200 is locked in the fuel injection valve receiving portion 103 of the fuel rail 100 (lock state). FIGS. 1 and 2 illustrate the state illustrated in FIG. 3A where the fuel injection valve 200 is unlocked in the fuel injection valve receiving portion 103. The fuel injection valve 200 rotates about the central axis 200A and is put into the lock state illustrated in FIG. 3B. Detailed description is as follows.

The plurality of protruding portions 109, slots 111 that are formed between the adjacent protruding portions 109, and the lock groove 110 that is formed at an insertion position for the protrusion-shaped portion 207 are formed in a lower end portion of the fuel injection valve receiving portion 103. The protruding portion 109 protrudes radially inward from an inner circumferential surface 108a that forms the groove portion 108. The five protruding portions 109 are formed at 60-degree intervals in the circumferential direction. The slot 111 constitutes a concave portion that is recessed radially outward from a tip portion of the protruding portion 109. The five slots 111 are formed at 60-degree intervals in the circumferential direction.

Convex portions (tabs) 209a are formed at an outer circumference of the plate 209 that is fitted into the fuel injection valve 200. The five convex portions 209a are formed at 60-degree intervals in the circumferential direction and protrude radially outward. The plate 209 is a member that forms the C-shaped annular shape. The groove portion 208 of the resin portion 205 has an inclined bottom surface portion 208a that is inclined for a groove depth to gradually decrease. A circumferential-directional positional deviation of the plate 209 from the fuel injection valve 200 is prevented by the inclined bottom surface portion 208a.

A 120-degree interval is disposed between the two slots 111 that are positioned in both circumferential-directional end portions. The lock groove 110 is formed at this interval part. A first groove portion (unlock fitting groove) 110a where the protrusion-shaped portion 207 is positioned during unlock, a second groove portion (lock fitting groove) 110b where the protrusion-shaped portion 207 is positioned during lock, and an inclined portion 110c that is formed between the first groove portion 110a and the second groove portion 110b constitute the lock groove 110.

The first groove portion 110a and the second groove portion 110b have sizes at which the protrusion-shaped portion 207 is fitted in a state where play is present. The inclined portion 110c is gently inclined, with respect to the circumferential direction, from the first groove portion 110a toward the second groove portion 110b. The inclined portion 110c is inclined, from the first groove portion 110a toward the second groove portion 110b, to approach the center O₁₀₃ of the fuel injection valve receiving portion 103. In other words, the inclined portion 110c is inclined so that an end portion on the first groove portion 110a side is positioned radially inward compared to an end portion on the second groove portion 110b side. The second groove portion 110b that has an inclined surface 110d which is inclined radially outward at a steep angle with respect to the circumferential direction is connected to an end portion of the inclined portion 110c on the side opposite to the first groove portion 110a side.

As described above, the protruding portions 109, the slots 111, and the convex portions 209a are disposed at 60-degree intervals. In FIG. 3A, the one-dot chain lines through central portions of the slots 111 and the convex portions 209a are drawn at 60-degree intervals. As illustrated in FIG. 3A, the convex portion 209a is fitted into the slot 111 so that the plate 209 is inserted into the groove portion 108 of the fuel injection valve receiving portion 103 with the convex portion 209a of the plate 209 and the protruding portion 109 not interfering with each other. In this case, the protrusion-shaped portion 207 is fitted into the first groove portion 110a, and the insertion of the plate 209 into the groove portion 108 is not impeded.

In this embodiment, the protruding portion 109 that is disposed in the fuel injection valve receiving portion and the convex portion 209a that is disposed in the plate 209 constitute a first lock mechanism. The protruding portion 109 and the convex portion 209a of the first lock mechanism constitute an engagement portion that regulates a movement of the fuel injection valve 200 in a central axis direction with respect to the fuel injection valve receiving portion 103, with the protruding portion 109 and the convex portion 209a overlapping with each other in the central axis direction, in a case where the fuel injection valve 200 rotates about the central axis 200A.

In addition, the protrusion-shaped portion 207 and the lock groove 110 constitute a second lock mechanism. The protrusion-shaped portion 207 and the lock groove 110 of the second lock mechanism regulate a rotational movement of the fuel injection valve about the central axis, with the protrusion-shaped portion 207 fitted into the second groove portion 110b of the lock groove 110, in a case where the fuel injection valve 200 rotates about the central axis.

In this embodiment, the first lock mechanism and the second lock mechanism are arranged at the same height position in the central axis 200A direction of the fuel injection valve 200.

In this embodiment, the fuel injection valve 200 is fixed to the fuel rail 100 through a three-step operation. In a first step, the fuel inlet side end portion 200I is inserted into the concave portion 106 of the fuel injection valve receiving portion 103. In this step, the annular seal member 202 is inserted into the inlet opening 106a of the concave portion 106 but is not inserted into the cylindrical surface portion 106b. In a second step, the annular seal member 202 is inserted into the cylindrical surface portion 106b. A state where the second step is completed is illustrated in FIGS. 2 and 3A. In a third step, the fuel injection valve 200 rotates about the central axis 200A and the protrusion-shaped portion 207 is moved from the first groove portion 110a to the second groove portion 110b.

When the protrusion-shaped portion 207 is moved from the first groove portion 110a to the second groove portion 110b, a tip portion of the protrusion-shaped portion 207 abuts against the inclined portion 110c of the lock groove 110. Since the protrusion-shaped portion 207 abuts against the inclined portion 110c, an external force that causes the central axis 200A to deviate from the center O₁₀₃ of the fuel injection valve receiving portion 103 acts on the fuel injection valve 200. The annular seal member 202 is an elastic member and can be deformed by the external force. The fuel outlet side end portion 200D is not fixed, and thus the central axis 200A of the fuel injection valve 200 can be inclined. Assisted by the deformation of the annular seal member 202 and the inclination of the central axis 200A of the fuel injection valve 200, the protrusion-shaped portion 207 can be moved to the second groove portion 110b over the inclined portion 110c of the lock groove 110. In this manner, the inclined portion 110c constitutes a guide portion that guides the movement of the protrusion-shaped portion 207 from the first groove portion 110a to the second groove portion 110b.

In this embodiment, the protrusion-shaped portion 207 is a resin and the lock groove 110 is a metal. Accordingly, the movement of the protrusion-shaped portion 207 over the inclined portion 110c of the lock groove 110 is facilitated, although slightly, by an elastic deformation of the protrusion-shaped portion 207.

The inclined portion 110c of the lock groove 110 is gently inclined with respect to the circumferential direction, and the external force that acts on the fuel injection valve gradually increases until the protrusion-shaped portion 207 is moved over the inclined portion 110c after the protrusion-shaped portion 207 starts to abut against the inclined portion 110c. Accordingly, no significant force is required for moving the protrusion-shaped portion 207 from the unlock position (unlock position) to the lock position (lock position).

The lock state that is illustrated in FIG. 3B occurs after the protrusion-shaped portion 207 is moved to the second groove portion 110b. In this state, the convex portions 209a is over the protruding portion 109 and the fuel injection valve 200 is prevented from falling out of the fuel injection valve receiving portion 103. Even if the protrusion-shaped portion 207 rotates in the circumferential direction, sudden abutting against the inclined surface 110d and separation from the second groove portion 110b are impossible. In this manner, a rotational position of the fuel injection valve 200 with respect to the fuel injection valve receiving portion 103 is also fixed.

The annular seal member 202 and the chip seals 211A and 211B are disposed in the fuel injection valve 200. The annular seal member 202 abuts against the cylindrical surface portion 106b of the concave portion 106. In addition, the chip seals 211A and 211B abut against the inner circumferential surface of the fuel injection valve insertion hole 1000a. Accordingly, resistance acts between the annular seal member 202 and the cylindrical surface portion 106b and between the chip seals 211A and 211B and the inner circumferential surface of the fuel injection valve insertion hole 1000a when the fuel injection valve 200 rotates about the central axis 200A. A rotational direction fixing force from the protrusion-shaped portion 207 and the second groove portion 110b may be small because of the presence of the resistance.

In this embodiment, retaining of the fuel injection valve 200 and fixing of a position in the rotational direction can be executed when the fuel injection valve 200 is allowed to rotate by approximately 30 degrees about the central axis 200A. Accordingly, the five protruding portions 109, the five slots 111, and the five convex portions 209a are disposed at 60-degree intervals and the one lock groove 110 and the one protrusion-shaped portion 207 are disposed.

As illustrated in FIG. 3B, the protrusion-shaped portion 207 is fitted into the second groove portion 110b in a state where the play is present, and a gap 61 is disposed between an outer circumferential portion of the convex portion 209a and the inner circumferential surface (bottom surface) 108a of the groove portion 108. In addition, the protrusion-shaped portion 207 is fitted into the second groove portion 110b, in a state where the play is present, also in the circumferential direction. In other words, the protrusion-shaped portion 207 is fitted into the second groove portion 110b in a loosely fitted state during lock. Accordingly, in the lock state, the fuel injection valve 200 is not rigidly fixed to the fuel injection valve receiving portion 103 and can be relatively displaced, although slightly, from the fuel injection valve receiving portion 103 in a direction orthogonal to the central axis 200A. Accordingly, a bending force attributable to a positional deviation between the fuel injection valve receiving portion 103 of the fuel rail 100 and the fuel injection valve insertion hole 1000a can be prevented from acting on the fuel injection valve 200.

In this embodiment, the entire lock mechanism that includes a detent mechanism is configured to be inside the fuel injection valve receiving portion 103 and the fuel inlet side end portion 200I of the fuel injection valve 200 is fitted into the fuel injection valve receiving portion 103 in the loosely fitted state. Accordingly, the mounting structure in which the external force is unlikely to act on the fuel injection valve 200 can be realized. In this manner, the fuel injection valve 200 is unlikely to cause a positional deviation about the central axis 200A after mounting, and thus a deviation in fuel injection direction can be prevented or suppressed.

In the related art, restraining of the fuel injection valve 200 is performed by fitting a clip into an outer side of a fuel injection valve receiving portion. In this embodiment, the restraining clip does not have to be disposed, and thus the number of components and the length of time consumed for assembly can be reduced.

In FIG. 2, a gap is present between a lower surface 209b of the plate 209 and an upper surface 109a of the protruding portion 109. This gap disappears when a fuel pressure acts on the fuel injection valve 200. In other words, the fuel injection valve receives the fuel pressure to be pressed downward, and the lower surface 209b of the plate 209 and the upper surface 109a of the protruding portion 109 abut against each other.

In this embodiment, the protrusion-shaped portion 207 is formed, by molding, in the resin portion 205. However, the protrusion-shaped portion 207 may be disposed in the plate 209. Usually, the plate 209 is made of metal. Accordingly, the protrusion-shaped portion 207 is supposed to be made of metal.

The number of the convex portions 209a that are disposed on the plate 209 is not limited to five. A rotation angle (lock angle) for the lock state is not limited to 30 degrees. Even in a case where the lock angle is 30 degrees, the number can be changed by adjusting the sizes and arrangement of the protruding portion 109, the slots 111, and convex portions 209a. For example, the lock angle can be set to a relatively small angle when the number of the convex portions 209a that are disposed on the plate 209 is increased. Even in a case where the lock angle is limited (an assembly space is required to be narrow), this embodiment is capable of addressing this advantageously if the lock angle is small.

The lock groove 110 disposed in the fuel injection valve receiving portion 103 may be disposed in the resin portion 205 or the plate 209 of the fuel injection valve 200, and the protrusion-shaped portion 207 disposed in the fuel injection valve 200 may be disposed in the fuel injection valve receiving portion 103. In a case where the protrusion-shaped portion 207 is disposed in the fuel injection valve receiving portion 103, the protrusion-shaped portion 207 is formed to protrude radially inward from an inner circumferential surface of the fuel injection valve receiving portion 103.

In the embodiment that is illustrated in FIG. 1, the nozzle portion 210 of the fuel injection valve 200 is inserted into the fuel injection valve insertion hole 1000a that is formed in the cylinder head 1000. Herein, an outer circumference of the nozzle portion 210 of the fuel injection valve is supported by the inner circumferential surface of the insertion hole 1000a. Specifically, the nozzle portion 210 is borne in a compressed state where the chip seals 211A and 211B are pinched by the nozzle portion 210 and the inner circumferential surface of the fuel injection valve insertion hole 1000a. Resistance in a direction in which the lock state of the plate 209 is released into the unlock state (direction in which the protrusion-shaped portion 207 is moved to the inclined portion 110C over the second groove portion 110B) is generated by the chip seals 211A and 211B, and returning from the lock state to the unlock state is suppressed.

A method for mounting on the fuel injection valve receiving portion 103 that is an injector cup in which the mounting structure for the fuel injection valve 200 described above is used will be described with reference to the accompanying drawings.

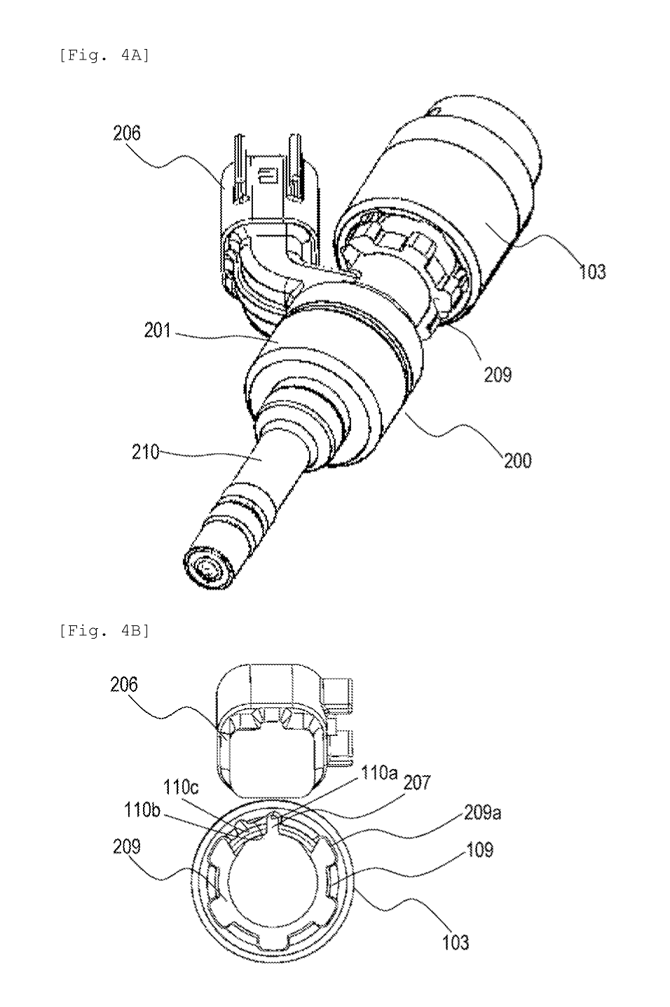

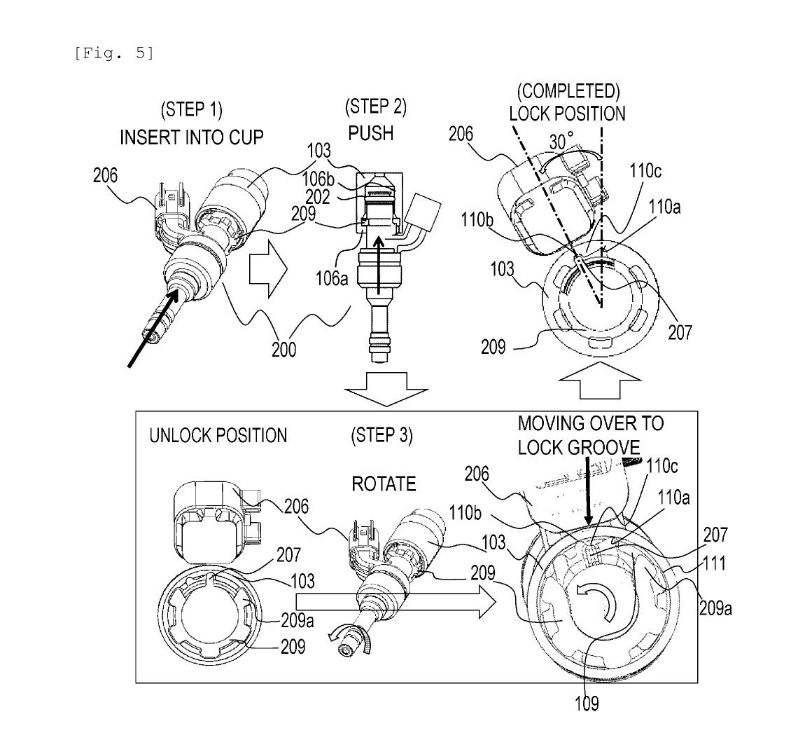

FIG. 4A is an external view illustrating a state where the fuel injection valve 200 according to this embodiment is mounted on the fuel injection valve receiving portion 103. FIG. 4B is a horizontal cross-sectional view illustrating a position where the plate 209 is mounted on the fuel injection valve 200. Like reference numerals are used to refer to those already described in the other drawings, detailed description of which will be omitted.

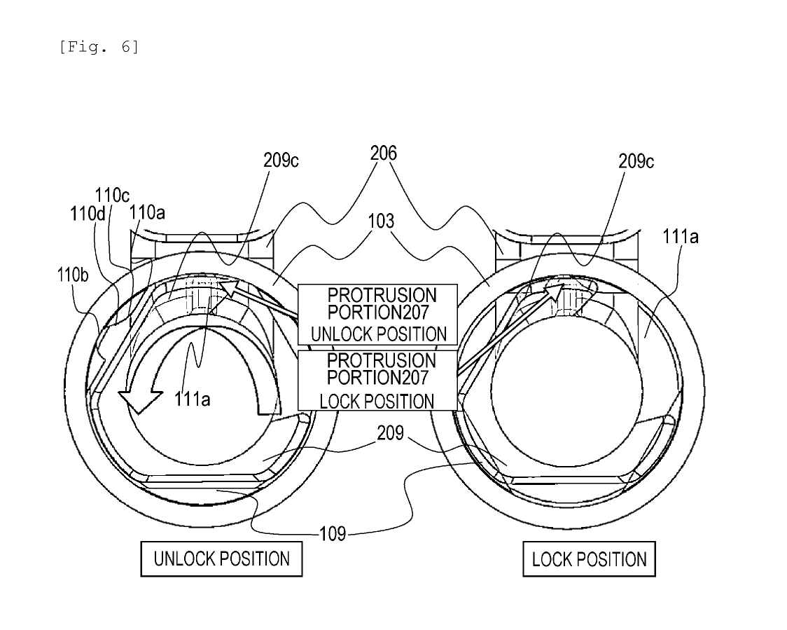

Hereinafter, the method for mounting the fuel injection valve 200 on the fuel injection valve receiving portion 103 will be described with reference to FIG. 5. At first, the fuel injection valve 200 on which the plate 209 is mounted is inserted into the fuel injection valve receiving portion 103 (injector cup) as illustrated in the first step. In the first step, the annular seal member 202 is inserted into the inlet opening 106a of the concave portion 106 but is not inserted into the cylindrical surface portion 106b as described above.

Then, as illustrated in the second step, the fuel injection valve 200 on which the plate 209 is mounted is pushed into the fuel injection valve receiving portion 103 (injector cup). In this case, the plate 209 of the fuel injection valve 200 can be moved axially upward because the slots 111 are formed at positions corresponding to the convex portions 209a of the plate 209 in the fuel injection valve receiving portion 103. In this case, the convex portions 209a of the plate 209 are pushed to a side above the protruding portion 109 of the fuel injection valve receiving portion 103 (injector cup).

Then, in the third step, the fuel injection valve 200 is rotated and the plate 209 is also rotated. Since the convex portions 209a of the plate 209 are in a state of being pushed to a side above the protruding portion 109 of the fuel injection valve receiving portion 103 (injector cup) as described above, the convex portions 209a and the protruding portion 109 do not interfere with the rotation of the plate 209. In this embodiment, the protrusion-shaped portion 207 of the fuel injection valve 200 is in contact with the lock groove 110 formed in the fuel injection valve receiving portion 103 (injector cup) when the plate 209 rotates as illustrated in the drawing on the right side in the third step. This interferes with the rotation of the fuel injection valve 200. In this embodiment, the inclined portion 110c that is connected to the first groove portion 110a and is inclined to an inner circumferential side is formed, and thus the protrusion-shaped portion 207 of the fuel injection valve 200 can be moved to the second groove portion 110b over the inclined portion 110c if a little power is applied.

A state where the movement of the protrusion-shaped portion 207 of the fuel injection valve 200 over the inclined portion 110c to the second groove portion 110b is completed is illustrated in the Lock Position (COMPLETED) in FIG. 5. In this state, the protrusion-shaped portion 207 of the fuel injection valve 200 is positioned in the second groove portion 110b, the inclined surface 110d is steeper than the inclined portion 110c, and the protrusion-shaped portion 207 of the fuel injection valve 200 is designed not to reversely get over (refer to FIG. 3B).

In this manner, the rotation of the fuel injection valve 200 with respect to the fuel injection valve receiving portion 103 (injector cup) can be suppressed and the fuel injection valve 200 can be fixed in the rotational direction.

In this state, the convex portions 209a of the plate 209 mounted on the fuel injection valve 200 are positioned on a side above the protruding portion 109 of the fuel injection valve receiving portion 103 (injector cup) and have overlap positions. In this manner, the convex portions 209a of the plate 209 mounted on the fuel injection valve 200 are axially supported by the protruding portion 109 of the fuel injection valve receiving portion 103 (injector cup) if the operation for pushing the fuel injection valve 200 is stopped. Accordingly, an axial movement of the fuel injection valve 200 with respect to the fuel injection valve receiving portion 103 (injector cup) can be suppressed and the fuel injection valve 200 can be fixed in the axial direction.

As described above, the fuel injection valve 200 mounted on the fuel injection valve receiving portion 103 according to this embodiment is provided with guided portions (protrusion-shaped portion 207 and convex portion 209a) guided to the fuel injection valve receiving portion and supported portions (protrusion-shaped portion 207 and convex portion 209a) supported by the fuel injection valve receiving portion 103. In the fuel injection valve receiving portion 103, a first guide unit (slot 111) is formed to guide the guided portion (convex portion 209a) in a push direction as the fuel injection valve 200 is pushed into the fuel injection valve receiving portion 103.

Second guide units (inclined portion 110c and inclined surface 110d) guiding the guided portion (protrusion-shaped portion 207) in the rotational direction in a case where the fuel injection valve 200 rotates in a state of being pushed into the fuel injection valve receiving portion 103 and regulating units (protruding portion 109, second groove portion 110b, and inclined surface 110d) regulating the movement of the supported portions (protrusion-shaped portion 207 and convex portion 209a) in an anti-push direction and an anti-rotational direction after the fuel injection valve 200 is guided by the second guide units (inclined portion 110c and inclined surface 110d) are formed in the fuel injection valve receiving portion 103.

In this embodiment, the regulating unit (protruding portion 109) regulating the movement in the anti-push direction and the regulating units (second groove portion 110b and inclined surface 110d) regulating the movement in the anti-rotational direction are disposed at different positions in the fuel injection valve receiving portion 103. Also, the regulating units may regulate the movements in the respective directions at the same places.

In this embodiment, the supported portion (convex portion 209a) regulating the movement in the anti-push direction and the supported portion (protrusion-shaped portion 207) regulating the movement in the anti-rotational direction are disposed at different positions in the fuel injection valve 200 to correspond to the regulating units (protruding portion 109, second groove portion 110b, and inclined surface 110d). Also, the movements in the respective directions may be regulated at the same places with regard to the supported portions (convex portion 209a and protrusion-shaped portion 207) as illustrated in the embodiment.

In the fuel injection valve receiving portion 103, a rotational direction regulating unit (protruding portion 109) is formed to regulate the movement of the guided portion of the fuel injection valve 200 in the rotational direction in a case where the fuel injection valve 200 rotates in a state of being pushed into a predetermined position in the fuel injection valve receiving portion 103. In other words, the guided portion (convex portion 209a) hits the rotational direction regulating unit (protruding portion 109) and the movement in the rotational direction is regulated if the fuel injection valve 200 is rotated in a state where the guided portion (convex portion 209a) is not pushed deeper than the protruding portion 109.

In this embodiment, a fixing member (plate 207) where the supported portion (convex portion 209a) is formed is mounted, and the fuel injection valve 200 is pushed into the fuel injection valve receiving portion 103 and is rotated, and then the movements in the anti-push direction and the anti-rotational direction are regulated in a state where the fixing member (plate 207) is mounted.

According to the mounting method of this embodiment described above, fixing for non-movement in the rotational direction and the axial direction with respect to the fuel injection valve receiving portion 103 (injector cup) can be achieved through the extremely simple operation of mounting the plate 209 on the fuel injection valve 200 and then pushing the plate 209 to the fuel injection valve receiving portion 103 (injector cup) and rotating the plate 209.

As another form of this embodiment, for example, it is desirable to constitute the protrusion-shaped portion 207 disposed in the fuel injection valve 200 by using an elastic member providing an elastic force toward a circumferential outer side. More specifically, it is desirable to constitute the protrusion-shaped portion 207 by using an elastic member protruding toward the side opposite to the rotational direction of the fuel injection valve 200, formed along the outer circumference of the fuel injection valve 200, and providing an elastic force toward a circumferential outer side by using the protruding place. In this manner, a fitting force toward the fitting groove (second groove portion) during lock can be increased and the lock state of the protrusion-shaped portion 207 disposed in the fuel injection valve 200 and the second groove portion can be ensured.

The protrusion-shaped portion 207 can have a latch structure when a spring is interposed between the protrusion-shaped portion 207 and the fuel injection valve 200. In this case, the protrusion-shaped portion 207 may be engaged with the fitting groove (second groove portion) due to a restoring force of the spring when the protrusion-shaped portion 207 is moved over the inclined portion 110C.

### Second Embodiment

Hereinafter, a second embodiment of the invention will be described with reference to FIG. 6. FIG. 6 is a cross-sectional view of the fuel injection valve receiving portion 103 (injector cup) and the plate 209 mounted on the fuel injection valve 200 according to this embodiment. In the fuel injection valve receiving portion 103 (injector cup), the protruding portions 109 are formed in three places. As in the first embodiment, the protrusion-shaped portion 207 is formed in the fuel injection valve 200. The drawing in the left of FIG. 6 illustrates the unlock position and the drawing in the right of FIG. 6 illustrates the lock position.

The three supported portions 209a are formed in the plate 209 mounted on the fuel injection valve 200. As in the first embodiment, an operator inserts the fuel injection valve 200 on which the plate 209 is mounted into the fuel injection valve receiving portion 103 (injector cup) and pushes the fuel injection valve 200 toward the fuel injection valve receiving portion 103 (injector cup) in the first step and the second step.

In this case, opening portions 111a are formed at positions corresponding to the supported portions 209a of the plate 209 in the fuel injection valve receiving portion 103, and thus the plate 209 of the fuel injection valve 200 can be moved axially upward. In this case, the supported portions 209a of the plate 209 are pushed to a side above the protruding portion 109 of the fuel injection valve receiving portion 103 (injector cup).

Then, in the third step, the fuel injection valve 200 is rotated and the plate 209 is also rotated. Since the supported portions 209a of the plate 209 are in a state of being pushed to a side above the protruding portion 109 of the fuel injection valve receiving portion 103 (injector cup) as described above, the supported portions 209a and the protruding portion 109 do not interfere with the rotation of the plate 209.

Even in this embodiment, the protrusion-shaped portion 207 of the fuel injection valve 200 is in contact with the lock groove 110 formed in the fuel injection valve receiving portion 103 (injector cup) when the plate 209 rotates. The protrusion-shaped portion 207 of the fuel injection valve 200 can be moved to the second groove portion 110b over the inclined portion 110c if a little power is applied in the rotational direction.

A state where the movement of the protrusion-shaped portion 207 of the fuel injection valve 200 over the inclined portion 110c to the second groove portion 110b is completed is illustrated in the Lock Position in FIG. 6. In this manner, the fuel injection valve 200 can be fixed in the rotational direction and the axial direction with respect to the fuel injection valve receiving portion 103 (injector cup) through a simple operation as in the first embodiment.

In this embodiment, one of the supported portions 209a formed in three places in the plate 209 is formed to overlap the protrusion-shaped portion 207 of the fuel injection valve 200 in the axial direction. The respective supported portions 209a of the plate 209 are formed at substantially equal intervals in the circumferential direction. Likewise, the protruding portions 109 of the fuel injection valve receiving portion 103 (injector cup) supporting the respective supported portions 209a of the plate 209 are formed at substantially equal intervals to correspond thereto.

In this manner, the load at a time when the plurality of protruding portions 109 of the fuel injection valve receiving portion 103 (injector cup) support the respective supported portions 209a of the plate 209 can be uniform, and thus the fuel injection valve 200 can be more firmly fixed.

### REFERENCE SIGNS LIST

100 Fuel rail
101 Fuel rail main body
103 Fuel injection valve receiving portion
109 Protruding portion
111 Slot
207 Protrusion-shaped portion
110 Lock groove
200 Fuel injection valve
209 Plate
209a Convex portion (tab)
205 Resin portion
110a First groove portion (unlock fitting groove)
110b Second groove portion (lock fitting groove)
110c Inclined portion
200D Fuel outlet side end portion
200I Fuel inlet side end portion
110d Inclined surface
202 Annular seal member
211A, 211B Chip seal
106 Concave portion of fuel injection valve receiving portion
106b Cylindrical surface portion of concave portion 106

1. A fuel injection device comprising a fuel rail and a fuel injection valve, the fuel rail including a fuel injection valve receiving portion receiving the fuel injection valve and a fuel inlet side end portion of the fuel injection valve being inserted into and fixed to the fuel injection valve receiving portion, the fuel injection device further comprising:
a first lock mechanism regulating a movement of the fuel injection valve in a central axis direction with respect to the fuel injection valve receiving portion; and
a second lock mechanism regulating a rotational movement of the fuel injection valve about a central axis,
wherein the first lock mechanism includes engagement portions respectively disposed in the fuel injection valve receiving portion and the fuel injection valve,
wherein the second lock mechanism includes a radially protruding protrusion-shaped portion in one of the fuel injection valve receiving portion and the fuel injection valve and a fitting groove into which the protrusion-shaped portion is fitted in the other one of the fuel injection valve receiving portion and the fuel injection valve, and
wherein the fuel injection device is in a lock state, with the engagement portion of the first lock mechanism engaged and the protrusion-shaped portion of the second lock mechanism fitted into the fitting groove, in a case where the fuel injection valve rotates about the central axis.

2. The fuel injection device according to claim 1,
wherein the first lock mechanism and the second lock mechanism are arranged at the same position in the central axis direction of the fuel injection valve.

3. The fuel injection device according to claim 2,
wherein the first lock mechanism and the second lock mechanism are arranged at different positions in circumferential directions of the fuel injection valve receiving portion and the fuel injection valve.

4. The fuel injection device according to claim 3,
wherein a plurality of protruding portions disposed on an inner circumferential surface side of the fuel injection valve receiving portion and protruding radially inward at intervals in the circumferential direction and a plurality of convex portions disposed on an outer circumferential surface of a plate fitted into the fuel injection valve and protruding radially outward at intervals in the circumferential direction constitute the engagement portion of the first lock mechanism, and
wherein the protrusion-shaped portion of the second lock mechanism is disposed on an outer circumferential surface of the fuel injection valve and the fitting groove of the second lock mechanism is disposed in an inner circumferential surface of the fuel injection valve receiving portion.

5. The fuel injection device according to claim 4,
wherein the protrusion-shaped portion of the second lock mechanism is formed in a resin portion integrally molded with a connector.

6. The fuel injection device according to claim 5,
wherein the protrusion-shaped portion of the second lock mechanism is disposed at a zero-degree, 90-degree, 180-degree, or 270-degree angular position about the central axis on the basis of the connector.

7. The fuel injection device according to claim 6,
wherein the second lock mechanism includes a lock groove, a first groove portion into which the protrusion-shaped portion is fitted during unlock, a second groove portion constituting the fitting groove, and an inclined portion for connection between the first groove portion and the second groove portion constituting the lock groove, and
wherein the inclined portion is inclined so that an end portion on the second groove portion side is positioned radially inward compared to an end portion on the second groove portion side.

8. The fuel injection device according to claim 7,
wherein the protrusion-shaped portion is fitted into the second groove portion, in a loosely fitted state, during lock.

9. A fuel injection valve mounted on a fuel injection valve receiving portion, comprising:
a guided portion guided to the fuel injection valve receiving portion; and
a supported portion supported by the fuel injection valve receiving portion,
wherein a first guide unit guiding the guided portion in a push direction as the fuel injection valve is pushed into the fuel injection valve receiving portion, a second guide unit guiding the guided portion in a rotational direction in a case where the fuel injection valve rotates in a state of being pushed into the fuel injection valve receiving portion, and regulating units regulating movements of the supported portion in an anti-push direction and an anti-rotational direction after the fuel injection valve is guided by the second guide unit are formed in the fuel injection valve receiving portion.

10. The fuel injection valve according to claim 9,
wherein the regulating unit regulating the movement in the anti-push direction and the regulating unit regulating the movement in the anti-rotational direction are disposed at different positions in the fuel injection valve receiving portion.

11. The fuel injection valve according to claim 9,
wherein the supported portion whose movement in the anti-push direction is regulated and the supported portion whose movement in the anti-rotational direction is regulated are disposed at different positions in the fuel injection valve.
